(19) United States
(12) Patent Application Publication
(10) Pub. No.: US 2016/0301194 A1
(43) Pub. Date: Oct. 13, 2016

(54) SPARK PLUG ELECTRODE TRIMMING TOOL FOR RACING VEHICLES

(71) Applicants: Kevin D. Peterson, Bristol, WI (US); Aloysius A. Hagemann, Bristol, WI (US)

(72) Inventors: Kevin D. Peterson, Bristol, WI (US); Aloysius A. Hagemann, Bristol, WI (US)

(21) Appl. No.: 14/684,347

(22) Filed: Apr. 11, 2015

(51) Int. Cl. H01T 21/02; B23D 59/00

(52) U.S. Cl. CPC H01T 21/02; B23D 59/00

(57) ABSTRACT

Pre-cut spark plugs with trimmed L-shaped electrodes are used in the racing industry for engines that are fueled by racing fuels such as high octane racing fuels and/or nitrous oxide or nitro methane, thus keeping the engine from detonating prematurely. However these spark plugs are expensive. Disclosed herein is a jig that trims the end of a standard commercial spark plug's L-shaped-electrode. The jig has a body and a finger screw that secures the spark plug body while exposing the L-shaped electrode. The spark plug is secured in the jig, and the jig secured in a vise so that a user may manually employ a saw such as a hacksaw to trim the end of the L-shaped electrode at a precise distance from the electrode's end that match the pre-cut spark plug's trimmed L-shaped electrode. This saves the user considerable expense.

This application claims the benefit of the U.S. Provisional Patent Application No. 61/985,591 filed Apr. 29, 2014 by the present inventors. This provisional patent application is incorporated herein by reference.

### BACKGROUND OF THE DISCLOSURE

Pre-cut commercially available spark plugs with trimmed L-shaped electrodes are used in the racing industry for engines that are fueled by racing fuels such as high octane racing fuels and/or nitrous oxide or nitro methane. This trimming keeps the engine from detonating prematurely. However these spark plugs are expensive. Standard spark plugs are sometimes used to replace the special commercially available spark plugs; they are modified by cutting off the tip of the L-shaped electrode analogous to the pre-cut commercially available spark plugs. However, this procedure requires the cut to be made at the precise place, and is both tedious and error prone. Therefore there is a need for a relatively inexpensive jig that a user can use to execute the cut precisely on a standard spark plug. Such a jig may save the user several hundred dollars a year.

### SUMMARY OF THE DISCLOSURE

Special spark plugs with trimmed L-shaped electrodes are used in the racing industry for engines that are fueled by racing fuels, thus keeping the engine from detonating prematurely. Disclosed herein is a jig that trims the end of a standard spark plug's L-shaped electrode. In the first embodiment, the jig has a body that accommodates the spark plug and a finger screw that secures the spark plug to the body while exposing the L-shaped electrode to be cut by a saw blade. A blade guide helps the user position the blade so a cut is made at the proper location. To use the jig, the spark plug is secured in the jig, and the jig secured in a vise so that a user may manually employ a blade such as a hacksaw to trim the end of the L-shaped electrode at a precise distance from the electrode's end. The jig is sized and configured so that the cut is made at the precise place.

### BRIEF DESCRIPTION OF THE DRAWINGS

FIG. 1 illustrates a front perspective view of the first embodiment of the present invention.

FIG. 2 illustrates a bottom perspective view of the first embodiment of the present invention.

FIG. 3 illustrates a front perspective view of the first embodiment of the present invention with spark plug installed and blade ready for use.

FIG. 4 illustrates a partial sectional view of FIG. 3.

FIG. 5 illustrates a detail of FIG. 4 after the blade has cut the tip of the electrode, shown in an expanded scale.

FIG. 6 illustrates the first embodiment of the present invention divided into three sections for exposition purposes.

FIG. 7 is a sectional view of FIG. 1.

FIG. 8 is a bottom view of the first embodiment of the present invention.

### LIST OF NUMERALS

### Number Part Names

102 jig
104 base
104a bottom section
104b middle section
104c top section
106 finger screw
108 groove
114 slot
116 cylindrical shaft
118 internal threads
120 bottom
122 blade guide
124a, 124b two stepped cylinders
204 spark plug threads
206 L-shaped electrode
208 central electrode
210 electrode end piece
212 hexagonal nut
214 washer
302 blade

### DETAILED DESCRIPTION OF THE DISCLOSURE

In the title, detailed description, and the appended claims, the following terms are used. The term “standard spark plug” refers to a spark plug that is compatible with a particular engine type of a racing vehicle. The term “racing fuels” refers to fuels used in racing vehicles such as, but not limited to, high octane racing fuels and/or nitrous oxide or nitro methane. The term racing vehicle similarly refers to any racing vehicle that uses racing fuels. The standard spark plug has an L-shaped electrode. Pre-cut matched spark plugs exists that work with the same engine as the standard spark plug, but are designed with a modified L-shaped electrode so that they eliminate premature detonation of the engine when the engine is installed in a racing vehicle such as, but not limited to, a racing automobile, or racing snowmobile. Examples of standard spark plugs commercially available at the time of the filing this paper are given in Table 1a and matched pre-cut spark plugs are given in Table 1b.

TABLE 1a
Standard spark plugs
Standard Plugs

AC 46-47
Champion 46-47
Autolite 46-47
Motorcraft 46-47
NG BR9ES
NG BR10ES

TABLE 1b
Matched Pre-Cut Spark Plugs
Matched Pre-Cut
Plugs

NGK 6
NGK 7

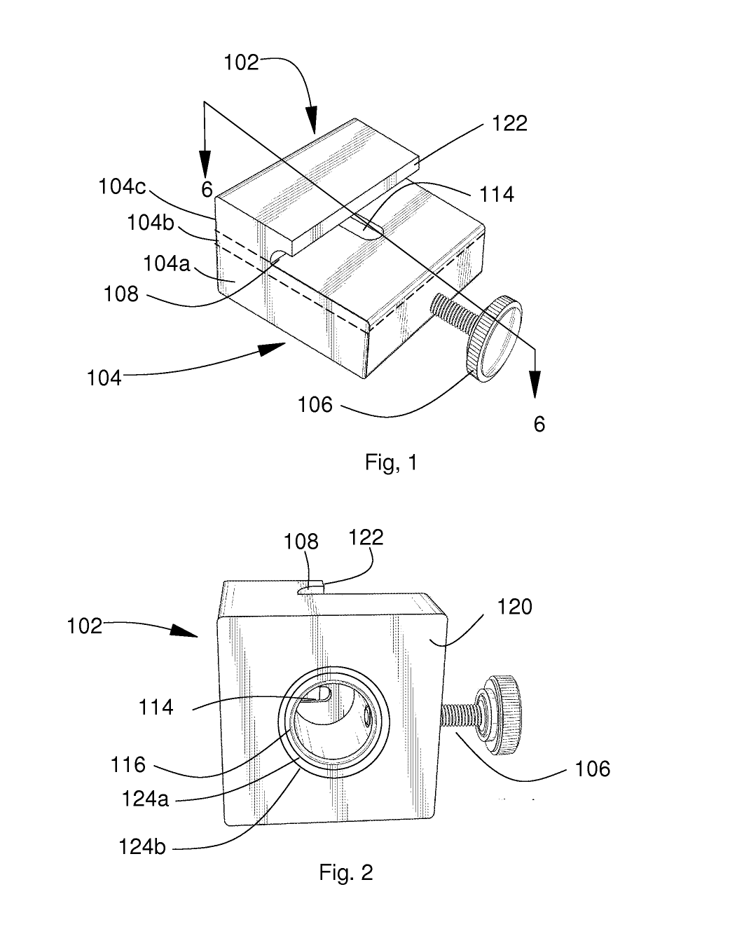

FIG. 1 illustrates a front perspective view of the first embodiment of the present invention. It is a jig 102 composed of two components, a base 104 and a finger screw 106. The finger screw 106 screws tightly into internal threads 118 located in the base 104 (internal threads 118 are not show in FIG. 1). The base has a groove 108, a blade guide 122 having a flat surface and a slot 114. Although the base in embodiment one is constructed out of a single piece of material, for exposition purposes it is divided into a bottom section 104a, a middle section 104b and a top section 104c in FIGS. 1 and 6.

FIG. 2 illustrates a bottom perspective view of the first embodiment of the present invention. Base 104 has a cylindrical shaft 116 passing through the bottom 120 of the base 104 whose longitudinal center is orthogonal to the surface of bottom 120. Also illustrated on the base is a groove 108, a slot 114, a blade guide 122, internal threads 118 and the finger screw 106. Also shown are two stepped cylinders 124a and 124b occurring at the bottom 120 of the cylindrical shaft 116. The two stepped cylinders 124a and 124b are sized and configured to accommodate racing spark plugs washers 214 for a variety of standard spark plugs.

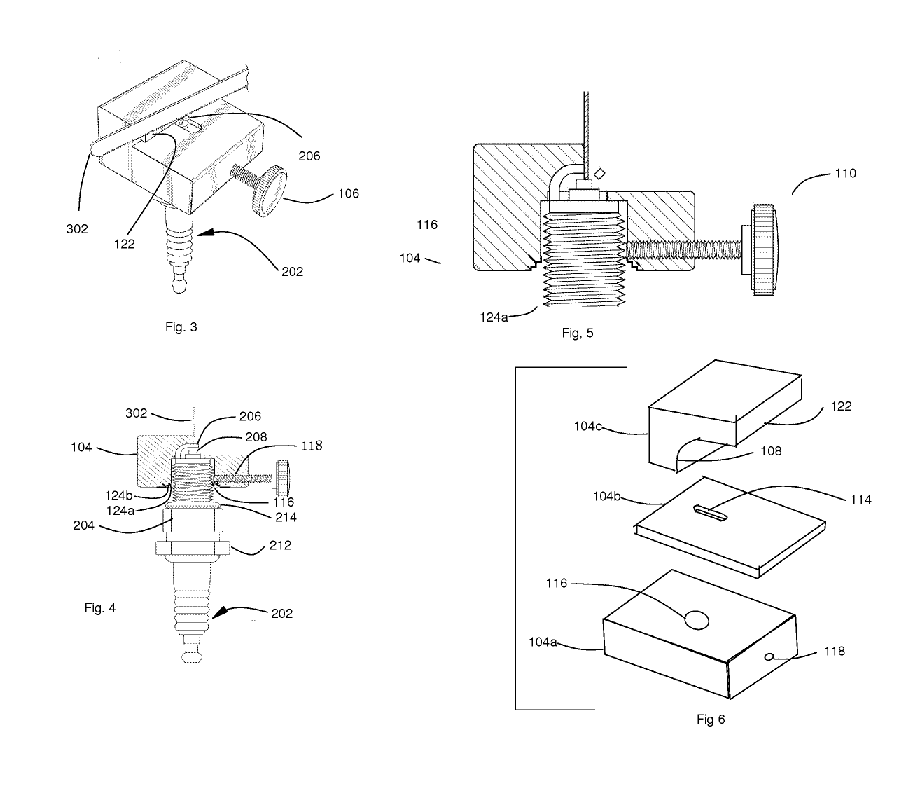

FIG. 3 illustrates a front perspective view of the first embodiment of the present invention with a standard spark plug 202 installed in jig 102 and with blade 302 ready for use. FIG. 4 illustrates a partial sectional view of FIG. 3. Referring to FIGS. 3 and 4, installation of the standard spark plug is done by placing the standard spark plug threads 204 into the cylindrical shaft 116 with the L-shaped electrode 206 protruding through the slot 114 and then turning the finger screw 106 until the spark plug is secured. The L-shaped electrode 206 has its electrode end piece 210 cut off in the proper location by cutting the L-shaped electrode while the side of the blade 302 is held against the blade guide 122. Cutting is stopped when the electrode end piece 210 breaks off, but before the blade makes contact with the central electrode 208. Groove 108, slot 114, and blade guide 122 are sized and configured so that the L-shaped electrode 206 fits against the curve of the groove and passes through the slot 114 such that the longitudinal axis of the L-shaped electrode is orthogonal to the surface of the blade guide 122.

FIG. 5 illustrates a detail of FIG. 4, shown in an expanded scale, after blade 302 has cut off an electrode end piece 210 of L-shaped electrode 206. The jig 102 is sized and configured so that when the spark plug is installed in the jig 102 and the electrode end piece 210 is cut off, the remaining part of the L-shaped electrode 206 has the proper position relative to the central electrode 208 to prevent premature detonation.

FIG. 6 illustrates an exploded view of the base 104 shown in FIG. 5, with the base 104 divided into three section, a bottom section 104a, a middle section 104b and a top section 104c for exposition purposes. The bottom section 104a is constructed out of an essentially rectangular piece of material with a cylindrical shaft 116 passing through the base bottom section with its longitudinal center orthogonal to the surface of bottom 120.

The middle section 104b is constructed out of an essentially rectangular piece of material with a slot positioned on its top surface.

The top section has a substantially rectangular shape but has a groove 108 cut out in one corner as shown, and a blade guide 122 positioned above the groove. The base 104 comprised of the bottom section 104a, the middle section 104b and top section 104c, are sized and configured so that the L-shaped electrode 206 fits against the curve of the groove and passes through the slot 114 and such that the longitudinal axis of the slot 114 is orthogonal to the surface of the blade guide 122.

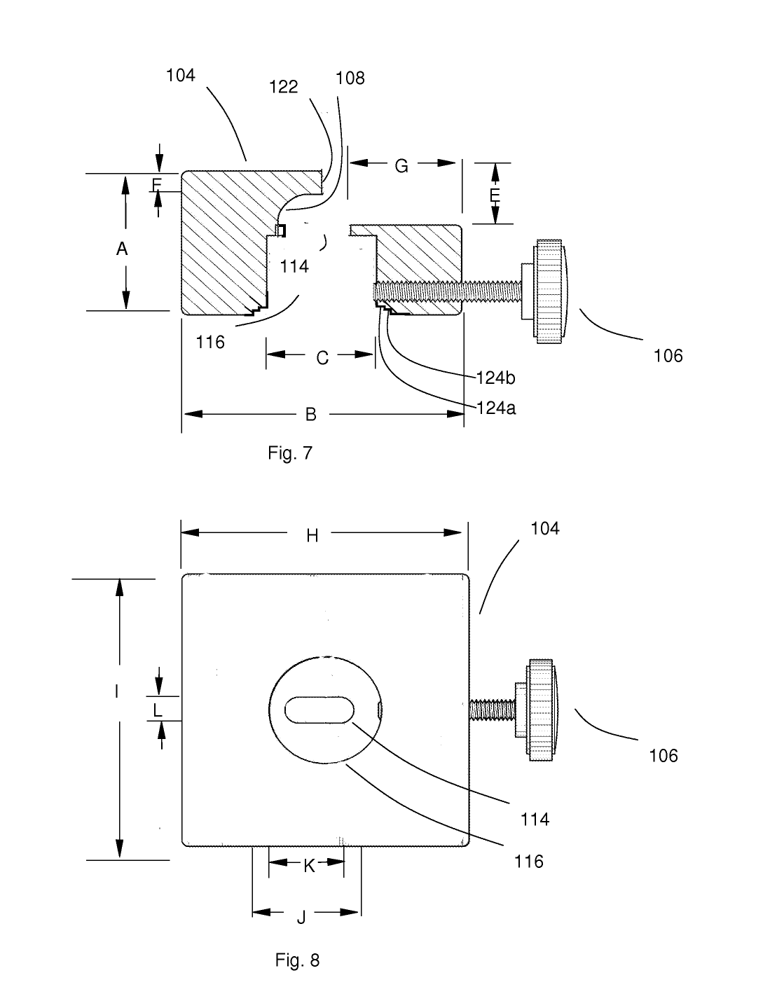

FIG. 7 is a sectional view of FIG. 1. FIG. 8 is a bottom view of the first embodiment of the present invention. The dimensions illustrated in FIGS. 7 and 8 are sized, depending on the particular spark plug used. Table 2 gives dimensions of FIGS. 7 and 8 for the first embodiment plug.

The first embodiment presented herein presents the design of a jig that cuts the electrode end piece 210 from a standard spark plug so that premature denotation is avoided for racing vehicle engines. The precise dimensions of the jig depend on the specific spark plug used. Table 2 gives the dimensions for the first embodiment.

TABLE 2
First Embodiment Jig Dimensions
Dimensions (inches)

| | |
|---|---|
| A | 1 |
| B | 1¾ |
| C | 11/16 |
| D | ⅞ |
| E | ⅜ |
| F | 3/16 |
| G | ⅞ |
| H | 1¾ |
| i | 1¾ |
| J | 11/16 |
| K | ½ |
| L | ⅛ |

Other embodiments are consistent with the inventive concept presented herein. For example, instead of using a finger screw pressing against the standard spark plug threads 204, the jig may be designed to hold the spark plug by different means. For example, the middle section 104b and top section 104c may be made out of a single piece of material, and the bottom section 104a made of a second single piece of material. For this embodiment the standard spark plug threads 204 may be screwed into the bottom section 104a, and then the middle section 104b then securely attached to the bottom section 104a. In another alternate embodiment, the spark plug may be clamped at its hexagonal nut 212. Similarly, the shape and dimensions of the base may vary. Additionally, the jig may have a motor driven saw as part of the jig that cuts the electrode end piece 210 properly, but stops before reaching the central electrode 208.

The disclosure presented herein gives several embodiments of the present invention. These embodiments are to be considered as only illustrative of the invention and not a limitation of the scope of the invention. Various permutations, combinations, variations and extensions of these embodiments are considered to fall within the scope of this invention. Therefore the scope of this invention should be determined with reference to the claims and not just by the embodiments presented herein.

What is claimed is:

1. A jig to be used on a standard spark plug having an L-shaped electrode for use in an engine fueled by racing fuels, said jig being sized and configured so that it securely holds said standard spark plug in a manner that permits a user to cut off a piece of said L-shaped electrode at a place such that premature detonation is avoided when said standard spark plug is installed in said engine.

2. A jig used for cutting an electrode end piece of an L-shaped electrode of a standard spark plug, said jig comprised of:
a base, said base comprised of:
a bottom section having a cylindrical shaft;
a middle section having a slot;
a top section comprised of a groove and a blade guide
a finger screw
wherein said jig is sized and configured such that if said standard spark plug is placed in said cylindrical shaft with said L-shaped electrode of said standard spark plug passing through said slot and is pressed against said groove, and said standard spark plug is then secured by tightening said finger screw, then a user can cut off a portion of said L-shaped electrode by placing a blade against said blade guide and cutting off said portion of said L-shaped electrode.

3. A jig used for cutting an electrode end piece of an L-shaped electrode of a standard spark plug, said jig comprised of:
a base, said base comprised of:
a bottom section, a middle section and a top section,
said bottom section having a substantially rectangular shape; said bottom section additionally having a cylindrical shaft passing through said bottom section, said cylindrical shaft having a longitudinal axis orthogonal to bottom said bottom section;
said middle section having a substantially rectangular shape, said middle section being positioned on top of said bottom section, said middle section having a slot positioned above said cylindrical shaft; said slot and said cylindrical shaft adapted so that a said L-shaped electrode of said standard spark plug can pass through said slot when said standard spark plug is inserted in said cylindrical shaft;
said top section having a substantially rectangular shape, having a cutout shaped like a groove such that said L-shaped electrode of said standard spark plug can fit against it and a blade guide positioned above said groove, said blade guide having a flat surface, said flat surface being positioned orthogonal to said longitudinal axis of said slot; and
a mechanism for securing said standard spark plug to said base
wherein said jig being sized and configured such that if said standard spark plug is placed in said cylindrical shaft with said L-shaped electrode of said standard spark plug passing through said slot and is pressed against said groove, and said standard spark plug is then secured by said mechanism for securing said standard spark plug, then a user can cut off a portion of said L-shaped electrode by placing a blade against said blade guide add cutting off said portion of said L-shaped electrode.

4. The jig of claim 3 wherein said mechanism for securing said standard spark plug to said base is a finger screw and said bottom section, said middle section and said top section are combined into a single piece of material.

5. The jig of claim 3 wherein said mechanism for securing said standard spark plug to said base is by screwing said standard spark plug threads located in said cylindrical shaft, located in said bottom section, said bottom section being comprised of a single piece of material, and then said middle section and said top section, comprised of a second single piece of material, is securely attached to said bottom section.
